(19) United States
(12) Patent Application Publication
(10) Pub. No.: US 2021/0162246 A1
(43) Pub. Date: Jun. 3, 2021

(54) Combine Harvester Fire Suppression System

(71) Applicant: Kevin McClellan, Cypress, IL (US)

(72) Inventor: Kevin McClellan, Cypress, IL (US)

(21) Appl. No.: 17/109,322

(22) Filed: Dec. 2, 2020

Related U.S. Application Data
(60) Provisional application No. 62/942,799, filed on Dec. 3, 2019.

(51) Int. Cl. A62C 3/07; A62C 37/00; A62C 99/00; A01D 75/20

(52) U.S. Cl. CPC A62C 3/07; A01D 75/20; A62C 99/0045; A62C 37/00

(57) ABSTRACT

A combine harvester fire suppression system is provided. The combine harvester fire suppression system includes a nozzle assembly. The nozzle assembly, formed by a number of nozzles that are connected by a nozzle tubing, is connected to a supply pipe. The supply pipe is connected to a primary fire extinguisher. Additionally, the supply pipe is connected to a secondary fire extinguisher. The supply pipe is also connected to a power source. The power source includes a manual control valve. The manual control valve is designed to release the primary fire extinguisher and the secondary fire extinguisher when it is pulled.

### CROSS REFERENCE TO RELATED APPLICATIONS

This application claims the benefit of U.S. Provisional Application No. 62/942,799 filed on Dec. 3, 2019. The above identified patent application is herein incorporated by reference in its entirety to provide continuity of disclosure.

### BACKGROUND OF THE INVENTION

The present invention relates to a combine harvester fire suppression system. More specifically, the present invention provides a safe, manually-actuatable system for putting out fires that develop on combine harvesters.

Many farmers use combination harvesters, or combines, to collect crops. During the operation of these combination harvesters, they may catch fire. These fires result from the dust and particulate matter that can accumulate when the combine is used for a prolonged period of time. These fires are incredibly damaging and can be extremely costly to repair. Additionally, the fires can cause serious injuries and, in some cases, deaths. Additionally, the crop damage that results from such a fire can be substantial.

Due to the nature of combine fires, fighting them with a handheld extinguisher may not be possible because the individual attempting to fight the fire with a handheld extinguisher would need to get dangerously close to the fire. Additionally, some harvesters have covers over the engine compartment. In the case oaf a fire in the engine compartment, the compartment would need to be opened in order to expose the fire to the extinguisher. A sudden rush of oxygen that could result from opening the compartment in such a situation could cause the fire to flare up causing serious injuries to the individual and bystanders. Therefore, a fire suppression system that can be manually operated from a safe distance and that can extinguish a fire on a combination harvester is desired.

### SUMMARY OF THE INVENTION

In view of the foregoing disadvantages inherent in the known types of combine harvester fire-fighting methods and systems now present in the prior art, the present invention provides a combine harvester fire suppression system wherein the same can be utilized for providing convenience for the user when suppressing a combine fire manually from the operator station of a combine harvester.

The present system comprises a nozzle assembly. The nozzle assembly comprises a plurality of nozzles disposed upon a nozzle tubing. The nozzle assembly is in operable connection with a supply pipe. A primary fire extinguisher is disposed on the supply pipe. Furthermore, a secondary fire extinguisher is disposed on the supply pipe. Additionally, a power supply is in operable connection with the supply pipe. A manual control valve is in operable connection with the power supply. The manual control valve configured to release the primary fire extinguisher and the secondary fire extinguisher when engaged by the user.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the combine harvester fire suppression system.

FIG. 2 shows a perspective view of an embodiment of the combine harvester fire suppression system.

FIG. 3 shows a perspective view of an embodiment of the combine harvester fire suppression system in use.

### DETAILED DESCRIPTION OF THE INVENTION

Reference is made herein to the attached drawings. Like reference numerals are used throughout the drawings to depict like or similar elements of the combine harvester fire suppression system. The figures are intended for representative purposes only and should not be considered to be limiting in any respect.

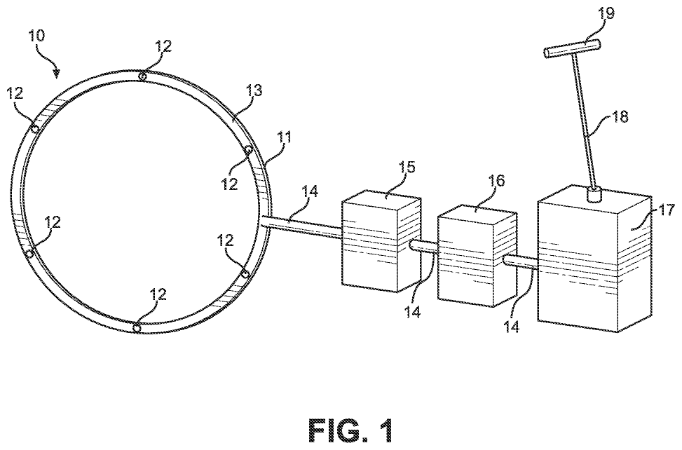

Referring now to FIG. 1, there is shown a perspective view of an embodiment of the combine harvester fire suppression system. The combine harvester fire suppression system 10 comprises a nozzle assembly 11. The nozzle assembly 11 comprises a plurality of nozzles 12. The plurality of nozzles 12 are disposed upon a nozzle tubing 13. The nozzle tubing 13 is of any suitable configuration for transporting fire retardant compounds from the entrance of the nozzle assembly 11 to the plurality of nozzles 12. For example, in some embodiments, the nozzle tubing is composed of copper tubing. As such, the nozzle tubing 13 will be lightweight, formable and durable. The nozzle assembly 11 is in operable connection with a supply pipe 14.

A primary fire extinguisher 15 is in operable connection with the supply pipe 14. The primary fire extinguisher 15 is configured to release a fire retardant compound when a release mechanism is engaged. In some embodiments, the primary fire extinguisher 15 comprises a dry chemical fire retardant. Furthermore, a secondary fire extinguisher 16 is in operable connection with the supply pipe 14. The secondary fire extinguisher 16 is further configured to release a fire retardant compound when a release mechanism is engaged. In some embodiments, the secondary fire extinguisher 16 comprises a dry chemical fire retardant, A power supply 17 is in operable connection with the supply pipe 14. The power supply 17 is configured to supply power to the release mechanisms of the primary fire extinguisher 15 and the secondary fire extinguisher 16. As such, the power supply 17 allows for the flow of fire retardant compound from the primary fire extinguisher 15 and the secondary fire extinguisher 16 into the supply pipe 14.

A manual control valve 18, 19 is in operable connection with the power supply 16. The manual control valve 18, 19 is configured to release the primary fire extinguisher 15 and the secondary fire extinguisher 16 when the manual control valve 18, 19 is engaged by the user. In the illustrated embodiment, the manual control valve 18, 19 comprises a pull cable 18. The pull cable 18 comprises a handle 19 disposed on a distal end thereof. The pull cable 18 is of any suitable configuration for engaging the primary fire extinguisher 15 and the secondary fire extinguisher 16. In some embodiments, the pull cable 18 is a steel-braided cable. As such, the strength of the pull cable 18 is enhanced, such as to prevent breaking of the pull cable 18.

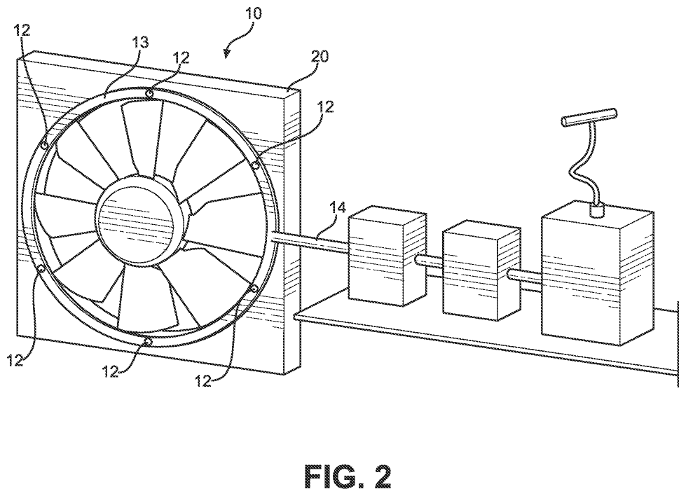

Referring now to FIG. 2, there is shown a perspective view of an embodiment of the combine harvester fire suppression system. In the illustrated embodiment, the nozzle assembly 12, 13 is disposed around a fan assembly 20. As such, when the combine fire suppression system 10 is engaged, the fan assembly 20 will assist in the dissemination of fire retardant compound from the primary fire extinguisher and the secondary fire extinguisher. The fan assembly 20 comprises a rotor 21 with a plurality of fan blades 22 radially extending outward therefrom. When power is applied to the rotor 21, the rotor 21 will rotate spinning the plurality of fan blades 22 and creating an air current. In the demonstrated embodiment, the rotor 21 and the plurality of fan blades 22 are housed within a fan shroud 23. The fan shroud 23 is configured to prevent dust, debris or combine harvester components from entering the path of the plurality of fan blades 22.

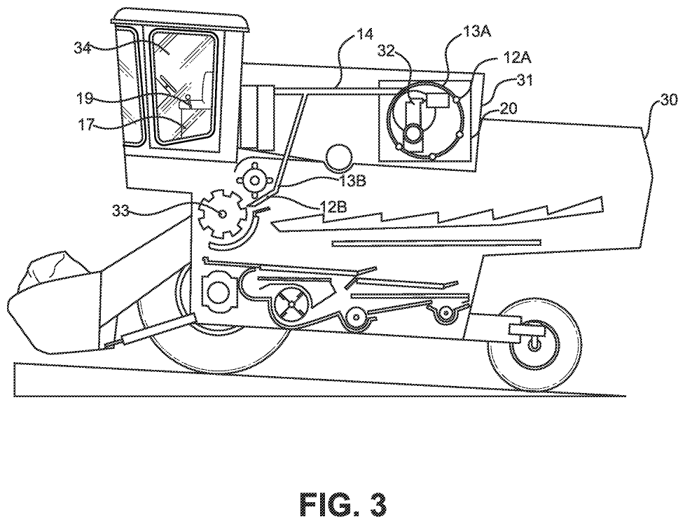

Referring now to FIG. 3, there is shown a perspective view of an embodiment of the combine harvester fire suppression system in use. In the illustrated embodiment, the combine harvester fire suppression system is installed upon a combine harvester 30. The components of the combine harvester fire suppression system may be placed in any ideal position depending on the specific make and model of the combine harvester 30. For the purpose of demonstrating the specific implementation of the combine harvester fire suppression system, a generic combine harvester is utilized.

When installed upon the combine harvester 30, the combine harvester fire suppression system may be oriented such as to direct fire retardant compounds to desired locations of the combine harvester 30. For example, the nozzle assembly may be oriented such that at least one nozzle 12a is disposed in an engine compartment 31 of the combine harvester 30. As such, any fires that start in the engine compartment 31 may be extinguished without needing to open the engine compartment 31 and risking exposure to dangerous flares from oxygen exposure. Furthermore, in the illustrated embodiment, the nozzle tubing 13a forms a circle around the engine 32 of the combine harvester 30. Additionally, in some embodiments, the nozzle tubing 13b forms an extension, such that at least one nozzle 12b is disposed in a shroud of a thresher 33 of the combine harvester 30. As such, fires near the thresher 33 of the combine harvester 30 may be extinguished by the combine harvester fire suppression system.

In the illustrated embodiment, the manual control valve 19 is installed within an operator station 34 of the combine harvester 30. As such, in the event of a fire, the combine operator may actuate the combine harvester fire suppression system without needing to exit the combine harvester 30. In this way, extinguishing the fire is safer for the operator as he or she does not need to expose himself or herself to the fire in order to extinguish it.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A combine harvester fire suppression system, comprising:
a nozzle assembly;
the nozzle assembly comprising a plurality of nozzles placed upon a nozzle tubing;
the nozzle assembly in operable connection with a supply pipe;
a primary fire extinguisher disposed on the supply pipe;
a secondary fire extinguisher disposed on the supply pipe;
a power supply in operable connection with the supply pipe;
a manual control valve in operable connection with the power supply;
the manual control valve configured to release the primary fire extinguisher and the secondary fire extinguisher when engaged.

2) The combine harvester fire suppression system of claim 1, wherein the manual control valve comprises a pull cable.

3) The combine harvester fire suppression system of claim 2, wherein the pull cable comprises a steel-braided cable.

4) The combine harvester fire suppression system of claim 1, wherein the manual control valve is installed within an operator station of a combine harvester.

5) The combine harvester fire suppression system of claim 1, wherein the nozzle assembly is disposed around a fan assembly.

6) The combine harvester fire suppression system of claim 1, wherein nozzle tubing comprises copper tubing.

7) The combine harvester fire suppression system of claim 1, wherein the nozzle assembly comprises at least one nozzle disposed in an engine compartment of a combine harvester.

8) The combine harvester fire suppression system of claim 1, wherein the nozzle assembly comprises at least one nozzle disposed in a shroud of a thresher of a combine harvester.

9) The combine harvester fire suppression system of claim 1, wherein the primary fire extinguisher comprises a dry chemical fire retardant.

10) The combine harvester fire suppression system of claim 1, wherein the secondary fire extinguisher comprises a dry chemical fire retardant.
